(19) United States
(12) Patent Application Publication
(10) Pub. No.: US 2016/0214113 A1
(43) Pub. Date: Jul. 28, 2016

(54) BIOCHIP HOLDER, METHOD FOR MANUFACTURING BIOCHIP HOLDER, BIOCHIP RETAINER, AND BIOCHIP HOLDER KIT

(71) Applicant: MITSUBISHI RAYON CO., LTD., Tokyo (JP)

(72) Inventor: Naoyuki TOGAWA, Yokohama-shi (JP)

(73) Assignee: Mitsubishi Rayon Co., Ltd., Chiyoda-ku, Tokyo (JP)

(21) Appl. No.: 14/917,482

(22) PCT Filed: Nov. 19, 2014
(86) PCT No.: PCT/JP2014/080657

§ 371 Date: Mar. 8, 2016

(30) Foreign Application Priority Data
Nov. 29, 2013 (JP) 2013-247265

(51) Int. Cl. B01L 9/00

(52) U.S. Cl. CPC B01L 9/52; B01L 2200/12; B01L 2300/0887; B01L 2200/02; B01L 2300/0893

(57) ABSTRACT

The purpose of this invention is to provide a biochip holder and holding kit that make it possible to efficiently process large numbers of biochips that have detection samples exposed on both sides. This invention provides a biochip holder characterized by having the following: a concavity (24) that accommodates a biochip (10); and support parts (26) that are provided at the edges of said concavity and support the biochip accommodated inside the concavity such that said biochip is substantially horizontal and the underside thereof is above the bottom surface (24a) of the concavity with a gap therebetween.

### FIELD OF THE INVENTION

The present invention relates to a biochip holder or the like, in particular, to a biochip holder or the like to be used when biochip ewashing procedures or the like are conducted.

### BACKGROUND ART

To examine substances contained in a sample derived from a living organism, a so-called biochip is known. Such a biochip is formed with detection reagents (probes) such as proteins, protein fragments, peptides, peptide derivatives, nucleic acids, nucleic acid derivatives, sugar chains and sugar derivatives, which are immobilized on a carrier made of glass, polymers, film or the like. Then, the sample derived from a living organism is reacted with the detection reagents so as to determine what substances are contained in the target.

As examples of such a biochip, DNA chips (DNA microarrays), antibody arrays, antigen arrays, peptide arrays and the like are known.

Analytical methods called DNA-chip methods use a DNA chip as an example of a biochip. In such an analytical method, numerous DNA fragments are densely arrayed and immobilized on a planar substrate, and are then hybridized with nucleic acids of the sample so that nucleic acid sequences in the sample are detected and quantified.

More specifically, in such a DNA-chip method as above, a specimen containing a sample labeled with a fluorescent dye, enzyme, low-molecular compound or the like is supplied to the DNA chip so that complementary nucleic acids are paired through hybridization. Then, signals emitted from the region containing a hybridized site are scanned by a high resolution analyzer.

Also, a through-hole type DNA chip (capillary array sheet) manufactured as follows is known (Patent publication 1): a hollow-fiber array is formed by immobilizing multiple hollow fibers using a resin or the like; from one end of the array, a solution of a polymerizable monomer such as acrylamide containing capture probes is introduced into each hollow fiber; after the solution is gelated, the fiber array is cut in a direction perpendicular to its longitudinal direction.

In such a capillary array sheet, the gel containing capture probes is filled in through holes that extend by penetrating through the chip in a thickness direction and is exposed on both of the chip surfaces. Accordingly, such a structure enables capture probes in the gel filled in the through holes to undergo reactions on both the upper and lower surfaces of the chip.

To process reactions of a sample with probes in a biochip such as a capillary array sheet capable of providing both surfaces of detection reagents, the chip is inserted into a holder formed specifically to fit the chip (Patent publication 2), and the holder is then mounted on a processing device designed specifically for that purpose.

However, the method described in Patent publication 2 was unable to promptly process a large number of chips, and thus was inefficient.

Meanwhile, in a proposed method capable of efficiently processing a large number of biochips, each biochip is processed by being accommodated in a well of a well plate where numerous concavities are formed on a plate surface (Patent publication 3).

### PRIOR ART PUBLICATION

### Patent Publication

Patent publication 1: JP2001-133453A

Patent publication 2: JP2005-121606A

Patent publication 3: Specification of U.S. Pat. No. 5,545,531

### SUMMARY OF THE INVENTION

### Problems to be Solved by the Invention

However, in the method described in Patent publication 3, biochips are each attached to the bottom of a well formed in the well plate and then undergo hybridization reactions or the like. Thus, the method is not suitable for processing biochips such as the aforementioned capillary array sheet where detection reagents are exposed on both chip surfaces.

The present invention was carried out to solve the above problems. Its objective is to provide a biochip holder, a method for manufacturing the biochip holder, a biochip retainer, and a biochip holder kit so as to achieve efficient processing of a large number of biochips where detection reagents are exposed on both of the chip surfaces.

### Solutions to the Problems

An embodiment of the present invention is a biochip holder structured to have a concavity for accommodating a biochip and to have support portions formed on the periphery of the concavity to support a biochip accommodated in the concavity in a way that the lower surface of the biochip is positioned upward away from the bottom surface of the concavity.

Such a structure is capable of efficiently processing a large number of biochips having detection reagents that are exposed on both of the chip surfaces.

According to a preferred embodiment of the present invention, the support portions are structured to support a biochip substantially horizontally.

According to another preferred embodiment of the present invention, the support portions are formed on the bottom of a concavity. In addition, it is an option to form a channel to connect a concavity to the outside of the concavity.

According to yet another preferred embodiment of the present invention, multiple concavities structured as above are formed on the plate surface.

Because of such a structure as above, biochips are efficiently processed by using an existing device for processing well plates.

According to yet another preferred embodiment of the present invention, at least part of the bottom surface of the biochip holder is formed with a film containing a cyclo-olefin copolymer.

Another embodiment of the present invention is a method for manufacturing a biochip holder, including a step for welding a film containing a cyclo-olefin copolymer to the bottom surface of a concavity of any of the aforementioned biochip holders.

Yet another embodiment of the present invention is a biochip retainer for securing a biochip accommodated in the concavity of a biochip holder, where the biochip holder is structured to have a concavity for accommodating a biochip and to have support portions formed on the periphery of the concavity to support substantially horizontally the biochip accommodated in the concavity in a way that the lower surface of the biochip is positioned upward away from the bottom surface of the concavity; and the biochip retainer is formed in a frame shape and abuts from above the periphery of the biochip accommodated in the concavity.

Such a biochip retainer structured as above is capable of preventing the lifting of a biochip accommodated in the concavity of a biochip holder, thus enabling proper washing, image scanning and the like to be conducted.

According to a preferred embodiment of the present invention, a notch is formed at the lower edge of a biochip retainer.

According to another preferred embodiment of the present invention, the biochip has a notch on its periphery, and such a notch is formed in a position to be aligned vertically with the notch of a retainer when the retainer abuts the periphery of the biochip.

Because of such a structure as above, a processing liquid containing a sample circulates efficiently to the lower-surface side of a biochip through the aligned notches of a retainer and of a biochip.

Yet another embodiment of the present invention is a biochip holder kit, which includes the following: a biochip holder structured to have a concavity for accommodating a biochip and to have support portions formed on the periphery of the concavity to support substantially horizontally a biochip accommodated in the concavity in a way that the lower surface of the biochip is positioned upward away from the bottom surface of the concavity; and a retainer for securing a biochip accommodated in the concavity of the biochip holder.

According to a preferred embodiment of the present invention, the retainer is formed in a frame shape and abuts the periphery of the biochip from above.

Such a structure as above is capable of preventing the lifting of a biochip, thus enabling proper washing, image scanning and the like to be conducted.

According to another preferred embodiment of the present invention, the retainer is structured to have a notch at its lower edge.

According to yet another preferred embodiment of the present invention, the biochip has a notch on its periphery, and such a notch is formed in a position to be aligned vertically with the notch of a retainer when the retainer abuts the periphery of the biochip.

Because of such a structure as above, a processing liquid containing a sample circulates efficiently to the lower-surface side of a biochip through the aligned notches of a retainer and of a biochip.

### Effects of the Invention

According to the present invention, a biochip holder, a method for manufacturing the biochip holder, a biochip retainer, and a biochip holder kit are provided so as to achieve efficient processing of a large number of biochips where detection reagents are exposed on both of the chip surfaces.

### BRIEF DESCRIPTION OF THE DRAWINGS

FIG. 1 is a perspective view schematically showing the structure of a DNA chip to be held by a biochip holder according to an embodiment of the present invention;

FIG. 2 is a perspective view schematically showing the structure of a biochip holder according to a preferred example of the present invention;

FIG. 3 is an enlarged perspective view showing a concavity of the biochip holder in FIG. 2;

FIG. 4 is a perspective view showing a state where the DNA chip in FIG. 1 is accommodated in the biochip holder in FIG. 3;

FIG. 5 is a perspective view schematically showing the structure of a retainer that forms a holder kit along with the biochip holder in FIG. 2;

FIG. 6 is a perspective view showing a state where the DNA chip is accommodated in the biochip holder in FIG. 3 and is secured by a retainer in FIG. 1;

FIG. 7 is a view schematically showing a state when the biochip holder of the embodiment is in use;

FIG. 8 is a perspective view schematically showing the structure of a biochip holder in another preferred example of the present invention; and

FIG. 9 is a perspective view schematically showing the structure of a biochip holder in yet another preferred example of the present invention.

### DETAILED DESCRIPTION OF THE EMBODIMENTS

In the following, a biochip holder according to a first embodiment of the present invention is described with reference to the accompanying drawings.

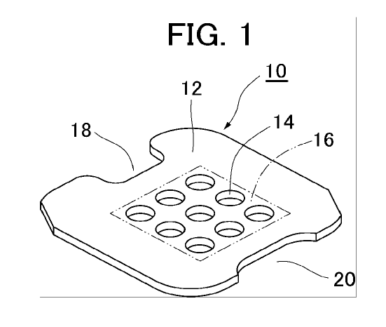

First, the structure of DNA biochip 10 is described as an example of a biochip to be held by the biochip holder. However, using a DNA chip is not the only option. FIG. 1 is a perspective view schematically showing the structure of DNA chip 10. In the present specification, a concavity of a biochip holder may be referred to as a well.

In the present embodiment, DNA biochip 10 to be held by the biochip holder is structured to have through holes. The shape of through holes is not limited specifically. For example, the horizontal cross-sectional shape of through holes may be any of a circle, ellipse or polygon. Considering the ease of manufacturing, a DNA chip is preferred to have a circular horizontal cross-sectional shape, namely, a columnar through hole manufactured by the method described in Patent publication 1 above. DNA biochip 10 is a so-called capillary array sheet formed by cutting a hollow-fiber bundle filled with a gel or a porous material containing detection reagents.

DNA biochip 10 is not limited to being a capillary array sheet with through holes. Other chip examples are planar substrates such as glass plates, resin plates and silicone plates in which detection reagents are immobilized on either surface or both surfaces. In the embodiments of the present invention, a planar substrate with detection reagents exposed on both surfaces is preferred, since effects of the present invention are more likely to be exhibited.

Predetermined detection reagents immobilized by group in certain spots at predetermined intervals on a planar substrate (spotting method or the like: see Science 270, 467-470 (1995), etc.), or predetermined detection reagents synthesized by group successively on certain spots of a planar substrate (photographic method or the like: see Science 251, 767-773 (1991), etc.), may be used.

DNA chip 10 has chip body 12 formed in a substantially rectangular shape. The shape of a DNA chip in FIG. 1 is substantially rectangular; however, the shape of a DNA chip in the embodiments of the present invention is not limited specifically, and may be selected appropriately accordingly to usage purposes or the like. For example, the shape may be substantially a square, circle, ellipse, polygon or the like. Multiple through holes 14 made of hollow fiber are formed in the center of chip body 12. To simplify descriptions, FIG. 1 schematically shows only nine through holes 14 made of hollow fiber set in a 3×3 array. However, the number of through holes is not limited to nine, and any other number may be employed. For example, a total of 108 through holes may be formed in a 9×12 array. Furthermore, using hollow fiber with a smaller inner diameter, a total of 456 through holes in a 24×19 array may also be employed. The center region of chip body 12 having such through holes 14 is set as detection reagent-holding region 16.

On both longitudinal ends of DNA chip 10 (short sides), notches 18, 20 are respectively formed to penetrate through chip body 12 in a thickness direction and to extend inward from a side edge of the chip. The number, shape, position and the like of notches are not limited specifically as long as the liquid to be filled in a well circulates through the notches to the lower portion of the biochip so that proper processing is also conducted on the lower surface of a biochip (the lower-side surface, that is, the surface facing the bottom of the well). The number of notches is preferred to be at least two. Notches are preferred to be positioned on two sides facing each other. Moreover, notch 20 is preferred to be greater than notch 18 as shown in the present embodiment. Such sizes are preferable, since more efficient washing is conducted by setting a washing-liquid supply nozzle to be above larger notch 20 and a suction nozzle to be above smaller notch 18 of DNA chip 10.

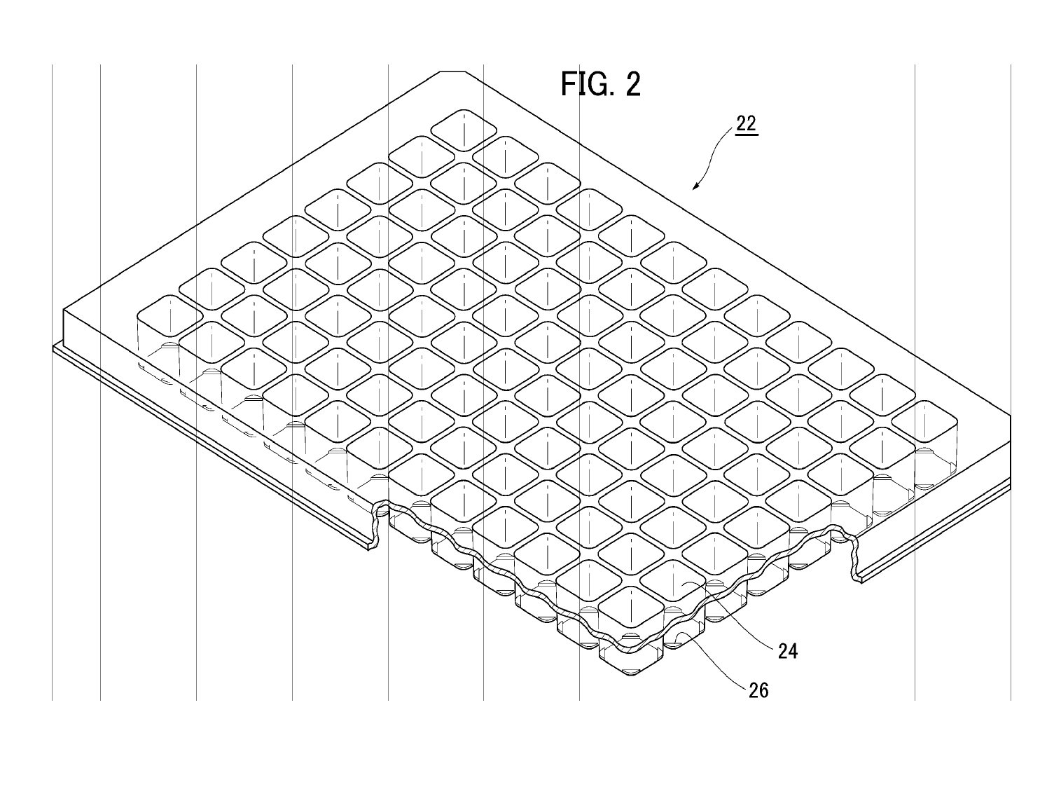

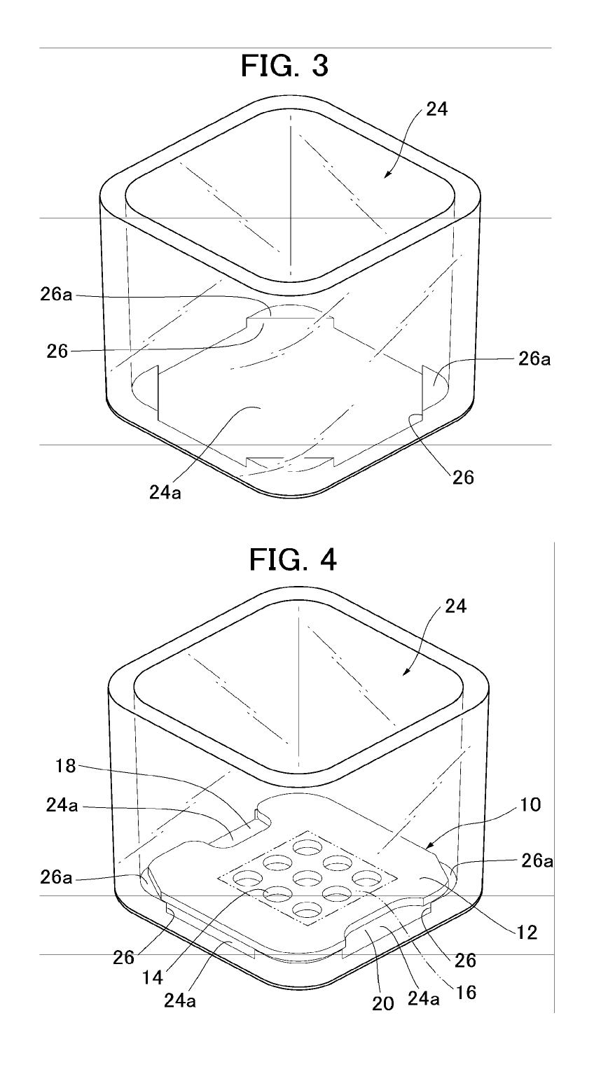

Next, the structure of biochip holder 22 of the present embodiment for supporting DNA chip 10 is described below. FIG. 2 is a perspective view schematically showing the structure of biochip holder 22, and FIG. 3 is an enlarged perspective view showing concavity 24 of biochip holder 22.

The number of concavities of a biochip holder is not limited specifically; it may be one or more. A biochip holder with multiple concavities enables multiple DNA chips to be processed simultaneously. For example, as shown in FIG. 2, biochip holder 22 is a well plate, more specifically, a well plate having 96 (8×12) wells formed in compliance with ANSI/SBS standards. However, that is not the only option; other well plates having a different number of wells, 384 wells, for example, may be used. Alternatively, depending on the shape of biochips, well plates in other shapes may also be used.

In addition, one or more channels may be formed so as to connect a well to the outside of the well. If a biochip holder has multiple wells, the holder may be structured to have a channel that connects wells to each other.

The material of the well plate is not limited specifically in the present embodiment, but materials with highly transparent properties are preferred, for example, glass, polymers or copolymers such as polypropylene, polyethylene, polyester, polymethyl methacrylate, polycarbonate, and polysulfone. Among those, it is more preferable to use a material containing cyclo-olefin copolymers having properties such as low fluorescence, high transparency and high heat tolerance, even more preferably, cyclo-olefin copolymers formed by copolymerizing norbornene and ethylene. In particular, preferred materials are “TOPAS” (brand name), made by Polyplastics Co., Ltd., which is known as a cyclo-olefin copolymer formed by copolymerizing norbornene and ethylene in the presence of a metallocene catalyst, or “ZEONEX” (brand name), made by Zeon Corporation, having properties the same as above.

In the embodiments of the present invention, light may be irradiated from the bottom of the biochip holder to conduct detection or analysis of DNA. Therefore, at least part of or the entire bottom surface of a well is preferred to be formed using the aforementioned material. Alternatively, a film made of the aforementioned material may be welded to the bottom portion of a biochip holder so as to provide such a material to the bottom of some or all of the concavities.

In addition, to carry out reactions, heat may be applied from the lower surface. Accordingly, the bottom surface is preferred to be protected by a heatproof protection film until a detection process is conducted.

As shown in FIG. 3, an example of well 24 of biochip holder (well plate) 22 is a concavity having a rectangular inner space with an opening on its upper end. As described above, the shape of a concavity may be a rectangle, a polygonal column or a circular column as long as DNA chip 10 is appropriately accommodated therein. In addition, a channel to circulate a liquid may be formed on a side surface of a concavity to be connected to the outside of the well plate. When such a channel is formed, a biochip holder may be used with its upper surface (the surface opposite the bottom of a concavity) closed. The dimensions and shape of the horizontal cross section in the inner space of well 24 are preferred to be set substantially the same as the planar shape of DNA chip 10 to be held therein. By so setting, DNA chip 10 is accommodated substantially horizontally in well 24.

When a biochip holder is used with its upper surface closed, there are no particular restrictions on the shape, material and the like of a member for closing the upper surface. A plate-type member or a sheet-type member may be used. The size of the member is not limited specifically, either. As long as the opening of a concavity is sufficiently covered, any appropriate material is selected according to the type or the like of a detection device. When a biochip holder has multiple concavities, a material is selected so as to sufficiently cover the multiple concavities. Moreover, the thickness of such a member is not limited specifically, and may be selected appropriately according to the type or the like of a detection device.

The material of such a member is not limited specifically, and it may be the same as or different from that of the well plate. The member is preferred to be formed with materials with high transparent properties; for example, glass, polymers or copolymers such as polypropylene, polyethylene, polyester, polymethyl methacrylate, polycarbonate, and polysulfone. Among those, it is more preferred to use a material containing cyclo-olefin copolymers having properties such as low fluorescence, high transparency, and high heat tolerance, even more preferably, cyclo-olefin copolymers formed by copolymerizing norbomene and ethylene.

In particular, preferred materials are “TOPAS” (brand name), made by Polyplastics, which is known as a cyclo-olefin copolymer formed by copolymerizing norbomene and ethylene in the presence of a metallocene catalyst, or “ZEONEX” (brand name), made by Zeon Corporation, having properties the same as above. Using such materials enables fluorescent illumination to be observed when excitation light is irradiated from above the well plate.

Support portions 26 are formed on the periphery of well 24 to support DNA chip 10 from below. Support portions 26 are preferred to be formed on the bottom periphery of well 24. Such a structure reduces the amount of liquid necessary to entirely immerse a biochip in the liquid, and efficient processing is thereby achieved.

For example, DNA chip 10 is supported by support portions 26 when its four corners each abut top surface 26a of support portion 26 (FIG. 4). As a result, DNA chip 10 accommodated in well 24 is supported by support portions 26 in a way that its lower surface is positioned upward away from bottom surface 24a of well 24. By setting the top surfaces of the support portions to have the same height, a DNA chip is supported substantially horizontally. In the embodiments of the present invention, it is not always necessary to support a DNA chip substantially horizontally, but holding a chip substantially horizontally is preferred because the chip is efficiently processed. At that time, top surface 26a of support portion 26 makes contact with the outer area of detection reagent-holding region 16 in DNA chip 10. Moreover, top surface 26a of support portion 26 makes contact with DNA chip 10 at a position that does not overlap vertically with notches 18, 20.

As shown in FIG. 3 and the like, in biochip holder (well plate) 22 of the present embodiment, support portions 26 are each preferred to be shaped in a substantially triangular column and positioned at a bottom corner of well 24, making contact with bottom 24a and an inner side surface of well 24; it is also preferred that support portions 26 be integrated with biochip holder (well plate) 22 and be made of the same material.

However, support portions 26 are not limited to the above. It is sufficient if support portions 26 can support a biochip substantially horizontally (substantially parallel to the bottom surface 24a of a well) while enabling the lower surface of the biochip to be positioned upward away from the bottom surface of a concavity.

Support portions 26 may be a polygonal column having at least four corners or a fan-shaped column. When well 24 has a rectangular horizontal cross section, support portions 26 are preferred to be positioned diagonally on the periphery. The number of support portions 26 is two or greater, preferably four. When there are four support portions, uneven distribution of the liquid seldom occurs.

The height from the bottom surface of well 24 to the top surface of support portion 26 (the thickness of support portion 26) may be selected appropriately according to the depth of well 24 or the thickness of a biochip (DNA chip 10). Preferably, the height is set so that approximately 10 μL˜100 μL of liquid, more preferably 20 μL˜60 μL, is filled in the space formed from the bottom surface in well 24 to the lower surface of a biochip that makes contact with support portion 26. A height within such a range secures sufficient space and will not decrease washing efficiency.

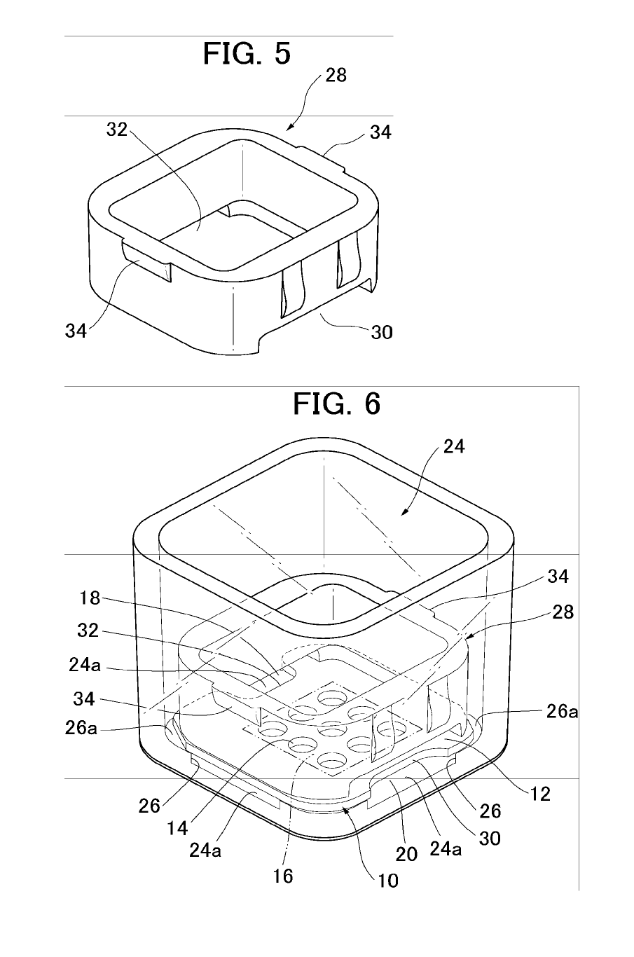

In biochip holder 22 of the present embodiment, a retainer is used; a retainer presses from above DNA chip 10 accommodated in well 24, secures or sandwiches DNA chip 10 between the retainer and support portions, and fixes the DNA chip to a predetermined position during a washing process. FIG. 5 is a perspective view schematically showing the structure of retainer 28 as an example of such a retainer.

As shown in FIG. 5, retainer 28 is preferred to be a frame-shaped member. Retainer 28 is set to have outer dimensions substantially the same as the inner dimensions of well 24. As shown in FIG. 6, retainer 28 is fitted into well 24 so that DNA chip 10 is sandwiched between the retainer and support portions 26. Here, a frame shape includes a ring, horseshoe shape, a shape where a side of the frame is missing, and the like.

The rectangular center space surrounded by the frame portion of retainer 28 is preferred to have such dimensions and shape that enable at least detection reagent-holding region 16 of DNA chip 10 to be exposed as shown in FIG. 6 when DNA chip 10 is sandwiched between the retainer and support portions 26. Such a structure maintains the quantification at the time of detection.

In addition, notches 30, 32 are formed at the lower portion of retainer 28. When DNA chip 10 is sandwiched between the retainer and support portions 26, notches 30, 32 are preferred to be positioned above notches 18, 20 of DNA chip 10 so that the lower surface of retainer 28 will not close notches 18, 20. It is especially preferable for notches of the retainer to be formed in positions that vertically align with the notches of a biochip.

Moreover, a pair of protrusions 34, 34 protruding sideways are preferred to be integrated on the upper edge of retainer 28. Such protrusions prevent shifting when the holder is agitated or put under centrifugation.

Paired protrusions 34, 34 are provided to be opposite each other on the upper end of retainer 28. When retainer 28 is fitted into well 24, protrusions press against the inner walls of well 24 so that retainer 28 is less likely to be pulled out of well 24.

However, as long as a biochip is prevented from being lifted, a retainer is not limited to being a specific type. For example, a retainer may be formed using a heavy material such as metal so that lifting of a biochip is prevented. In addition, the shape of a retainer may be a frame, a ring, or a shape where part of a frame or a ring is missing such as a U-shape, a C-shape or an L-shape.

In the present embodiment, retainer 28 is made of a thermoplastic resin material such as polypropylene, polyethylene, polymethyl methacrylate or polycarbonate. However, any other material may be used unless it prohibits detection processes such as hybridization reactions and antigen-antibody reactions.

During the detection process of fluorescence, poor signal-to-noise ratios will result if autofluorescence of a plug is strong, and detection accuracy is thereby lowered. Thus, it is necessary to select a material with low autofluorescence. When materials with strong autofluorescence are used, additives that absorb fluorescence, for example, carbon blacks, are added therein so that the level of autofluorescence is lowered.

Such a retainer, along with the aforementioned biochip holder, may be used or distributed as a kit.

Next, an explanation is provided on the use of a biochip holder of the present embodiment.

First, DNA chip 10 is introduced into each well 24 of well plate 22 to be examined. DNA chip 10 is positioned on support portions 26 in well 24 (FIG. 4). Next, retainer 28 is inserted into each well 24 to sandwich DNA chip 10 between retainer 28 and support portions 26.

At that time, support portions 26 and retainer 28 abut DNA chip 10 at outer positions of detection reagent-holding region 16. In addition, notches 30, 32 of retainer 28 are positioned above notches 18, 20 of DNA chip 10 so that notches 18, 20 of DNA chip 10 remain open vertically.

In addition, since a pair of protrusions 34, 34 formed on the upper edges of retainer 28 press against the inner-wall surfaces of well 24, retainer 28 is firmly fixed to well 24. Accordingly, DNA chip 10 is also firmly secured in well 24.

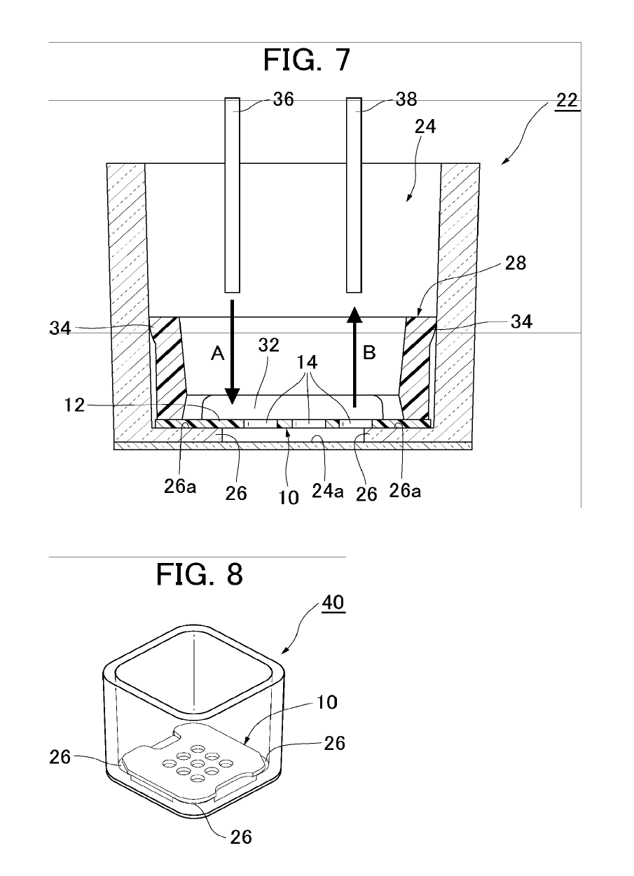

FIG. 7 is a view schematically showing how a biochip holder of the present embodiment is used. As shown in FIG. 7, in biochip holder 22 of the present embodiment, a space is formed under DNA chip 10 which is supported by support portions 26 to be positioned above bottom surface 24a of well 24. Thus, after hybridization, a washing liquid supplied from washing-liquid supply nozzle 36 of an automatic processing device such as a plate washer enters the space under DNA chip 10 as indicated by arrow A. As a result, the lower-surface side of DNA chip 10 is efficiently washed. The washing liquid is drained through suction nozzle 38 as indicated by arrow B.

In addition, by setting washing-liquid supply nozzle 36 to be above larger notch 20 of DNA chip 10 and suction nozzle 38 to be above smaller notch 18 of DNA chip 10, further efficient washing is achieved.

After a washing process or the like is conducted, a detection process is carried out by irradiating excitation light on the well plate, preferably, from below the well plate, so as to detect fluorescent illumination.

The present invention is not limited to the embodiments above. Various modifications and variations are possible as long as they do not deviate from the technological concept described in the scope of the claims.

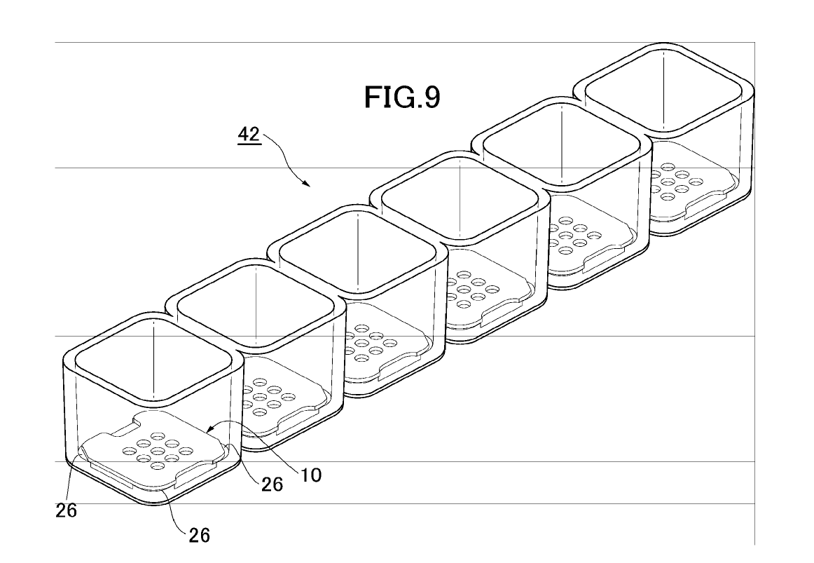

Biochip holder 22 of the above embodiment is a so-called well plate where multiple wells are arrayed two-dimensionally (in a grid). However, that is not the only option. Other structures such as the following may also be employed: biochip holder 40 with only one well (FIG. 8); biochip holder 42 with multiple (eight) wells arrayed lineally (FIG. 9); and the like.

In the above embodiments, a DNA chip was used as a biochip. However, the present invention is also effective in holding other biochips such as antibody arrays, antigen arrays, and peptide arrays.

### EXAMPLES

Examples of the present invention are described below. In the examples, a 0.12 M Tris-HCl/0.12 M NaCl/0.05% Tween-20 solution is used as a TNT buffer solution, and a 0.12 M Tris-HCl/0.12 M NaCl solution is used as a TN buffer solution.

### Example 1

A 96-square well plate was prepared, having well intervals in compliance with ANSI/SBS standards (distance between centers of wells: 9 mm). In the well plate, support portions with a thickness of 400 μm and having the same structures as those of support portions 26 of the above embodiment are formed in four corners of the bottom surface of each well. The entire well plate is made of cyclo-olefin copolymer (brand name TOPAS, made by Polyplastics), which enables fluorescence to be detected from the bottom-surface side.

DNA chips made by Mitsubishi Rayon Co., Ltd. were prepared. Each DNA chip is 7.4 mm long×7.4 mm wide and 0.25 mm thick, and includes gel spots arrayed in 9 rows and 12 columns.

In addition, a retainer was prepared, being made of polycarbonate resin with added carbon blacks, and having the same features as those shown in FIG. 5 (approx. 7.5 mm long×7.5 mm wide, height of notches at approx. 300 μm)

The above DNA chip was accommodated in each well of the well plate and secured by the retainer.

Next, a Cy5-Streptavidin solution (hereinafter referred to as a “Cy5 solution”) to be used in experiments was prepared as follows.

To Cy5-Streptavidin (1 mg, GE Healthcare #PA45001), 1 mL of sterile water was added and dissolved slowly to avoid foaming. Then, 102 μL each of the solution was dispensed into eight tubes, and the remaining solution was discarded. The solution in eight tubes was kept in shade at −20° C. until needed. Before using, 100 μL was taken from one of the eight tubes and mixed with 50 mL of a TN buffer solution.

From the prepared 50 mL of a Cy5 solution, 300 μL was poured into each of two areas of wells and the plate was agitated at 700 rpm. When fluorescence was observed from below by using a CCD-camera type detector made by Mitsubishi Rayon, the fluorescence was found to have reached a saturation point in all the chips.

Next, the plate was washed four times with 300 μL of a TNT buffer solution using a HydroFlex microplate washer (made by Tecan Trading AG), and the plate was agitated at 700 rpm. Then, the plate was put under centrifugation for 1 minute. After that, the same as above, a CCD-camera type detector made by Mitsubishi Rayon was used to observe fluorescence from below, and the fluorescence intensity was found to be stable in all the chips. The value was approximately 500.

### Comparative Example 1

Experiments were conducted by accommodating DNA chips in wells the same as in Example 1 except for using a 96-square well plate where no support portion was formed on the bottom of each well.

From the prepared 50 mL of a Cy5 solution, 300 μL was poured into each of two areas of wells, and the plate was agitated at 700 rpm. Then, when fluorescence was observed from below using a CCD-camera type detector made by Mitsubishi Rayon, only spots were observed, and no Cy5 solution was found to be distributed to the lower surfaces of the chips.

### DESCRIPTION OF NUMERICAL REFERENCES

10: DNA chip
12: chip body
14: through hole
16: detection reagent-holding region
18, 20: notch
22: biochip holder
24: concavity
26: support portion
26a: top surface
28: retainer
30, 32: notch

1. A biochip holder, comprising:
a concavity for accommodating a biochip; and
a support portion formed on a periphery of the concavity to support the biochip accommodated in the concavity such that a lower surface of the biochip is positioned upward away from a bottom surface of the concavity.

2. The biochip holder according to claim 1, wherein the support portion is configured to support a biochip substantially horizontally.

3. The biochip holder according to claim 1, wherein the support portion is formed on the bottom of the concavity.

4. The biochip holder according to claim 1, wherein a plurality of concavities are formed on a plate surface.

5. The biochip holder according to claim 1, wherein at least part of the bottom surface of the biochip holder is formed with a film comprising a cyclo-olefin copolymer.

6. A method for manufacturing a biochip holder, the method comprising welding a film comprising a cyclo-olefin copolymer to the bottom surface of the concavity of the biochip holder of claim 1.

7. A biochip retainer for securing a biochip accommodated in a concavity of a biochip holder, wherein:
the biochip holder is configured to have a concavity for accommodating a biochip and a support portion formed on a periphery of the concavity to support substantially horizontally the biochip accommodated in the concavity in a way that a lower surface of the biochip is positioned upward away from a bottom surface of the concavity; and
the biochip retainer is formed in a frame shape and abuts from above the periphery of the biochip accommodated in the concavity.

8. The biochip holder according to claim 7, wherein a notch is formed at a lower edge of the biochip retainer.

9. The biochip holder according to claim 8, wherein the biochip has a notch on its periphery, and the notch is formed in a position to be aligned vertically with the notch of a retainer when the retainer abuts the periphery of the biochip.

10. A biochip holder kit, comprising:
a biochip holder configured to have a concavity for accommodating a biochip and a support portion formed on a periphery of the concavity to support substantially horizontally a biochip accommodated in the concavity in a way that a lower surface of the biochip is positioned upward away from a bottom surface of the concavity; and
a retainer for securing a biochip accommodated in the concavity within the concavity.

11. The biochip holder kit according to claim 10, wherein the retainer is formed in a frame shape and abuts the periphery of the biochip from above.

12. The biochip holder kit according to claim 10, wherein the retainer is configured to have a notch at its lower edge.

13. The biochip holder kit according to claim 12, wherein the biochip is configured to have a notch on its periphery, and the notch is formed in a position to be aligned vertically with the notch of a retainer when the retainer abuts the periphery of the biochip.
